(19) United States
(12) Patent Application Publication
(10) Pub. No.: US 2008/0091615 A1
(43) Pub. Date: Apr. 17, 2008

(54) CONTENTS SERVICE APPARATUS AND METHOD

(75) Inventors: Hyok-sung Choi, Yongin-si (KR); Sang-kwon Lee, Suwon-si (KR); Se-jun Han, Daejeon Metropolitan-city (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/775,285

(22) Filed: Jul. 10, 2007

Related U.S. Application Data
(60) Provisional application No. 60/851,760, filed on Oct. 16, 2006.

(30) Foreign Application Priority Data
Dec. 29, 2006 (KR) 10-2006-0138787

(51) Int. Cl. H04L 9/08

(52) U.S. Cl. 705/71

(57) ABSTRACT

A method, apparatus, and system for intermediating contents service. The method includes changing at least part of contents to produce a plurality of pieces of changed key data which are different from each other; and managing trading of the contents between a first and a second device using the produced plurality of pieces of changed key data. The apparatus includes a contents publishing unit which changes at least part of contents, produces a plurality of pieces of changed key data which are different from each other, and stores information on the plurality of pieces of changed key data in a storage unit; and a trade managing unit which manages trading of the contents between a first device and a second device using the stored information on the plurality of pieces of changed key data. The system includes a contents service intermediating server, and first and second devices for trading contents.

### CROSS-REFERENCE TO RELATED PATENT APPLICATION

This application claims the benefit of priority from U.S. Provisional Patent Application No. 60/851,760 filed on Oct. 16, 2006 in the U.S. Patent Trademark Office, and priority from Korean Patent Application No. 10-2006-0138787, filed on Dec. 29, 2006, in the Korean Intellectual Property Office, the disclosures of which are incorporated herein in their entirety by reference.

### BACKGROUND OF THE INVENTION

1. Field of the Invention

Methods, apparatuses and systems consistent with the present invention relate to contents providing services, and more particularly, to intermediating between a contents provider and a contents user, providing, and using a contents service, and a contents service system.

2. Description of the Related Art

Due to an increase in online contents trading, digital rights management (DRM) technology is used to protect the rights, interests, and copyrights of contents providers and to protect against unauthorized duplication of their contents. However, since a closed DRM policy is generally applied, contents providers are subject to a specific DRM technology. Furthermore, related art DRM technologies do not allow purchased contents to be reproduced in different media or devices, which restricts rights of authorized contents consumers. The related art DRM technologies also make it difficult to trade contents between individuals and to find out who has distributed contents that have been duplicated or distributed without authorization.

### SUMMARY OF THE INVENTION

The present inventive concept provides a contents service method and apparatus, in which an open DRM policy is used, authorized users are free to use their acquired contents, it is easy to find out who has acquired contents that have been duplicated or distributed without authorization, and authorized users trade their acquired contents in person, and a contents service system thereof.

According to an aspect of the present invention, there is provided a method of intermediating a contents service, the method comprising changing at least part of contents and producing a plurality of pieces of changed key data which are different from each other; and managing trading of the contents between a first device and a second device using the produced plurality of pieces of changed key data.

The producing of the plurality of pieces of changed key data may comprise receiving key data comprising the at least part of the contents used for reproducing the contents from the first device; inserting different keys into the received key data to produce the plurality of pieces of changed key data; and transmitting the produced plurality of pieces of changed key data to the first device.

The method may further comprise determining whether the received key data has been changed; and if the received key data is determined to have been changed, notifying the first device that the contents are not allowed to be published.

The method may further comprise extracting the keys inserted into the key data that is determined to have been changed; and determining which customer has purchased the key data that is determined to have been changed based on trade records corresponding to the extracted keys.

The managing of the trading of contents may comprise receiving notification of purchase of contents, including information on a customer who purchased the contents and information on one of the plurality of pieces of changed key data, from the first device; and storing trade records of the customer regarding the contents.

The method may further comprise managing credit indicating a privilege granted to a customer for acquiring the contents.

The managing of the credit may comprise receiving a request for examining the credit, including identification information on the customer, from the first device; examining the credit based on credit information of the customer; and transmitting a result of the credit examination to the first device.

The managing of the credit may further comprise receiving a request for purchasing credit from the second device; and recording credit information of a customer in response to the request.

According to another aspect of the present invention, there is provided a method of providing a contents service, the method comprising receiving a plurality of pieces of changed key data which are different from each other and are produced by changing at least part of contents; and trading the contents using the received plurality of pieces of changed key data.

The receiving of the plurality of pieces of changed key data may comprise transmitting key data comprising the at least part of the contents used for reproducing the contents to a contents service intermediating server; and receiving the plurality of pieces of changed key data which are different from each other from the contents service intermediating server.

The plurality of pieces of changed key data may be produced by inserting different keys into the key data comprising the at least part of the contents.

The trading of the contents may comprise if a request for purchasing the contents is received from a second device, transmitting one of the plurality of pieces of changed key data to the second device.

The trading of the contents may further comprise transmitting notification of contents purchase, including information on a customer who purchased the contents and information on the transmitted one piece of changed key data, to the contents service intermediating server.

The trading of the contents may further comprise if the request for purchasing the contents is received from the second device, requesting the contents service intermediating server to examine credit in order to determine whether a customer who wishes to purchase the contents has a privilege for acquiring the contents; and if it is determined by the contents service intermediating server that the customer has the privilege for acquiring the contents, transmitting one of the plurality of pieces of changed key data to the second device.

According to another aspect of the present invention, there is provided a method of using a contents service, the method comprising transmitting a request for purchasing contents to a first device; receiving changed key data from the first device, the changed key data being produced by changing key data including at least part of the contents; and combining the received changed key data and parts of the contents other than the key data.

The method may further comprise transmitting a request for downloading the contents to the first device; and receiving the parts of the contents from the first device.

The method may further comprise purchasing credit indicating a privilege granted to a customer for acquiring the contents from a contents service intermediating server.

According to another aspect of the present invention, there is provided an apparatus for intermediating a contents service, the apparatus comprising a contents publishing unit which changes at least part of contents, produces a plurality of pieces of changed key data which are different from each other, and stores information on the produced plurality of pieces of changed key data in a storage unit; and a trade managing unit which manages trading of the contents between a first device and a second device using the stored information on the plurality of pieces of changed key data.

According to another aspect of the present invention, there is provided an apparatus for providing a contents service, the apparatus comprising a contents publishing unit which receives a plurality of pieces of changed key data which are different from each other and are produced by changing at least part of contents in a storage unit; and a trading unit which trades the contents with a second device using the stored plurality of pieces of changed key data.

According to another aspect of the present invention, there is provided an apparatus for using a contents service, the apparatus comprising a contents purchasing unit which transmits a request for purchasing contents to a first device, and receives changed key data from the first device which is produced by changing key data including at least part of the contents; and a contents reproducing unit which combines the received changed key data and parts of the contents other than the key data in order to reproduce the contents.

According to another aspect of the present invention, there is provided a contents service system including a contents service intermediating server, and first and second devices trading contents, wherein the contents service intermediating server changes key data of the contents and produces a plurality of pieces of changed key data which are different from each other to publish the contents; the first device, if the first device receives a request for purchasing the contents from the second device, transmits one of the plurality of pieces of changed key data to the second device; and the second device combines the transmitted one of the plurality of pieces of changed key data and parts of the contents other than the key data in order to reproduce the contents.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a contents service system according to an exemplary embodiment of the present invention;

FIG. 2 is a flowchart of a method of intermediating a contents service between two devices, according to an exemplary embodiment of the present invention;

FIG. 3 is a flowchart of a method of providing a contents service, according to an exemplary embodiment of the present invention;

FIG. 4 is a flowchart of a method of using a contents service, according to an exemplary embodiment of the present invention;

FIG. 5 is a dataflow diagram illustrating a method of publishing contents, according to an exemplary embodiment of the present invention;

FIG. 6 is a dataflow diagram illustrating a method of browsing contents, according to an exemplary embodiment of the present invention;

FIG. 7 is a dataflow diagram illustrating a method of examining credit, according to an exemplary embodiment of the present invention;

FIG. 8 is a dataflow diagram illustrating a method of reproducing contents, according to an exemplary embodiment of the present invention; and

FIG. 9 is a dataflow diagram illustrating a method of protecting contents from unauthorized duplication, according to an exemplary embodiment of the present invention.

### DETAILED DESCRIPTION OF EXEMPLARY EMBODIMENTS OF THE PRESENT INVENTION

The present inventive concept will now be described more fully with reference to the accompanying drawings, in which exemplary embodiments of the present inventive concept are shown.

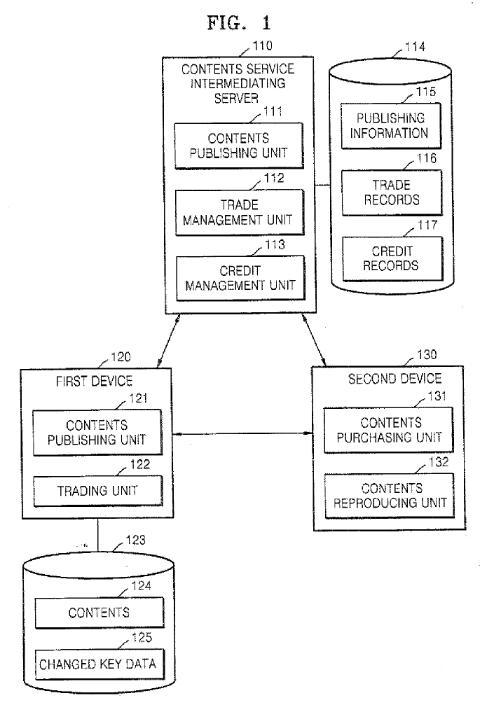

FIG. 1 is a block diagram of a contents service system according to an exemplary embodiment of the present invention. Referring to FIG. 1, the contents service system comprises a first device 120, a second device 130, which are contents traders, and a contents service intermediating server 110 that publishes contents and manages trades of the contents. The first device 120, the second device 130 and the contents service intermediating server 110 are computing systems each including a memory, a processor, and an input/output unit. The present inventive concept is applicable to all types of contents, such as audio, video, a picture, and the like, into which a fingerprint can be inserted.

The contents service intermediating server 110 is a device that maintains information on the first device 120, which is a contents provider for example, and the second device 130, which is a contents user for example, and trades records and credit indicating a privilege granted to a customer for acquiring contents. Before a contents service starts, the first device 120 and the second device 130 are authenticated by the contents service intermediating server 110 and allocated with respective identifiers (IDs). The contents service intermediating server 110 stores ID information of the first device 120 and the second device 130. The contents service intermediating server 110 includes a contents publishing unit 111 and a trade management unit 112, and stores publishing information 115 and trade records 116 in a storage unit 114, and manages them. The contents service intermediating server 110 further includes a credit management unit 113 that manages customer credit indicating a privilege granted to a customer for acquiring contents, stores information on credit purchase and use as credit records 117 in the storage unit 114, and manages the information.

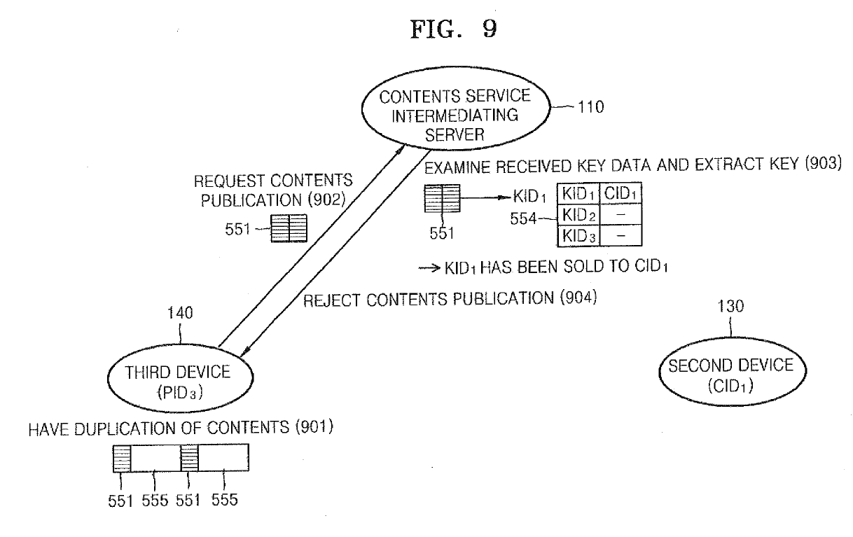

The first device 120, which, for example, is a contents service providing device for publishing and selling contents, includes a contents publishing unit 121 that publishes the contents through the contents service intermediating server 110 and a trading unit 122 that trades the contents, and stores contents 124 and changed key data 125 that are results obtained by publishing the contents in a storage unit 123. The second device 130, which, for example, is a device for browsing the contents and purchasing or acquiring the browsed contents, includes a contents purchasing unit 131 and a contents reproducing unit 132, and can further include a storage unit (not shown) for storing the purchased contents. According to another exemplary embodiment, one device may include all the constituents of the first and second devices 120 and 130, and both provide the contents and purchase the contents. Moreover, the contents can be traded between consumers in person. The detailed description of each of the constituents will be described later with reference to FIG. 9.

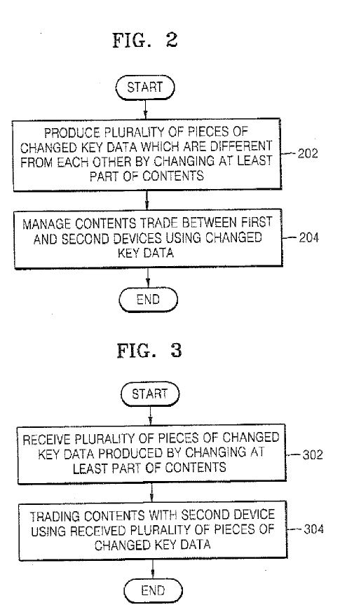

FIG. 2 is a flowchart of a method of intermediating a contents service, according to an exemplary embodiment of the present invention. Referring to FIG. 2, the contents publishing unit 111 of the contents service intermediating server 110 changes at least part of the contents to produce a plurality of pieces of changed key data which are different from each other in order to publish the contents (Operation 202). In this application, “key data” denotes a part of the contents which is indispensable for reproducing the contents. For example, since it is impossible to reproduce contents such as motion picture data according to the MPEG2 or MPEG4 standards without I frames, the I frames can be used as the key data. The contents publishing unit 111 inserts a plurality of different fingerprints into original key data to convert the key data into the plurality of pieces of changed key data. When the contents are substantially reproduced, a user cannot notice a difference between the original key data and the changed key data. Furthermore, security technology such as a watermark can be applied to the insertion of fingerprints so that the contents service intermediating server 110 only can change the original key data and extract keys from the changed key data.

Information on the changed key data is stored as the publishing information 115 in the storage unit 114 and used to manage the trading of contents between the first device 120 and the second device 130 (Operation 204). In detail, whenever the contents are sold or provided, a different piece of changed key data is provided to a customer. The trade management unit 112 manages records regarding which customer has purchased which piece of changed key data of the contents.

FIG. 3 is a flowchart of a method of providing a contents service, according to an exemplary embodiment of the present invention. Referring to FIG. 3, the contents publishing unit 121 of the first device 120 receives the plurality of pieces of changed key data that are results of the contents publishing and stores them in the storage unit 123 (Operation 302). The contents publishing unit 121 of the first device 120 can extract key data containing the at least part of the contents from the contents, transmit the extracted key data to the contents service intermediating server 110 in order to make a request for publishing the contents, and receive the plurality of pieces of changed key data in response to the request for publishing the contents. Alternatively, the contents publishing unit 121 can publish the contents in person (i.e., itself) and produce the plurality of pieces of changed key data.

The plurality of pieces of changed key data 125 stored in the storage unit 123 are used to provide the second device 130 with the contents (Operation 304). The trading unit 122 receives a purchase request from a customer and transmits one of the plurality of pieces of changed key data 125 to the second device 130. The trading unit 122 can examine credit of the customer, and if it is determined that the customer is authorized to purchase the contents, transmit one of the plurality of pieces of changed key data 125 to the second device 130. The contents service intermediating server 110 can determine the credit of the customer. The trading unit 122 can transmit information on the customer and the transmitted one piece of changed key data to the contents service intermediating server 110 and notify the contents service intermediating server 110 of the purchase fact.

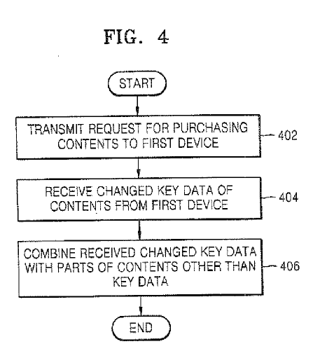

FIG. 4 is a flowchart of a method of using a contents service, according to an exemplary embodiment of the present invention. Referring to FIG. 4, the contents purchasing unit 131 of the second device 130 that is to purchase or acquire the contents transmits a request for purchasing desired contents to the first device 120 that is a contents provider (Operation 402). Before transmitting the request, the contents purchasing unit 131 can connect to the contents service intermediating server 110, browse the desired contents, and acquire connection information on the first device 120 providing the contents or connection information on the contents from the contents service intermediating server 110. However, it will be obvious to those of ordinary skill in the art that the connection information need not be necessarily acquired from the contents service intermediating server 110 but can be acquired by using other methods. The contents purchasing unit 131 receives changed key data of the contents from the first device 120 that has received the request, and completes a trade (Operation 404).

The contents reproducing unit 132 combines the received changed key data and parts of the contents, i.e., the contents other than the key data, and uses or reproduces the combination (Operation 406). The contents purchasing unit 132 can receive the parts of the contents from the first device 120 (i.e., the parts that are not key data) before transmitting the request to the first device 120. The first device 120 can distribute the parts of the contents without examining credit. This is because it is impossible to use or reproduce the contents with only the non-key parts of the contents. However, it will be obvious to those of ordinary skill in the art that the second device 130 can acquire the parts of the contents from another source and that the second device 130, but not necessarily limited thereto, receives the parts of the contents before transmitting the request to the first device 120.

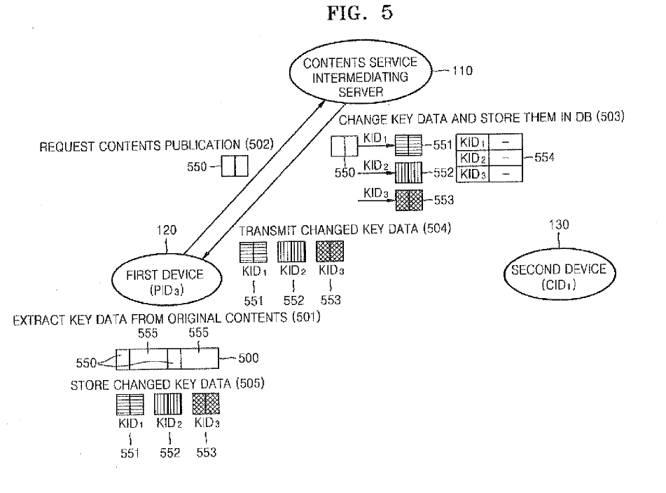

FIG. 5 is a dataflow diagram illustrating a method of publishing contents, according to an exemplary embodiment of the present invention. Referring to FIG. 5, the contents publishing unit 121 of the first device 120 extracts key data 550 from original contents 500 (Operation 501) and transmits the extracted key data 550 to the contents service intermediating server 110 in order to perform a request for publishing the contents (Operation 502). The contents publishing unit 111 of the contents service intermediating server 110 converts the received key data 550 into three pieces of changed key data 551, 552, and 553 using three different unique keys KID₁, KID₂, and KID₃, and stores the publishing information 115 including information on the keys KID₁, KID₂, and KID₃ in a database DB 554 (Operation 503). The DB 554 is used to store the publishing information 115 and the trade records 116 as illustrated in FIG. 1. The changed key data 551, 552, and 553 are transmitted to the first device 120 (Operation 504). The contents publishing unit 121 of the first device 120 stores the received changed key data 551, 552, and 553 so as to completely publish the contents (Operation 505).

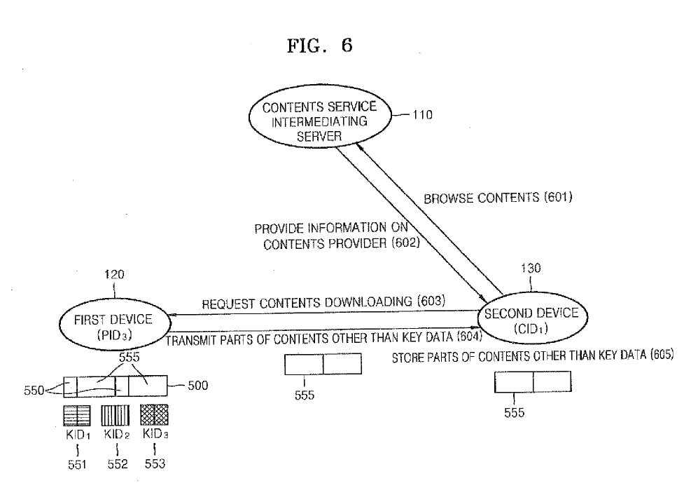

FIG. 6 is a dataflow diagram illustrating a method of browsing contents, according to an exemplary embodiment of the present invention. Referring to FIG. 6, the second device 130 that wishes to acquire contents connects to the contents service intermediating server 110 and browses the contents (Operation 601). The contents service intermediating server 110 browses the contents satisfying browsing conditions provided by the second device 130 and transmits information on the first device 120 from which the second device 130 can obtain the contents to the second device 130 (Operation 602). The second device 130 sends a request to the first device 120 to download the contents (Operation 603). The first device 120 transmits a portion 555 of the contents excluding the key data 550 to the second device 130 (Operation 604).

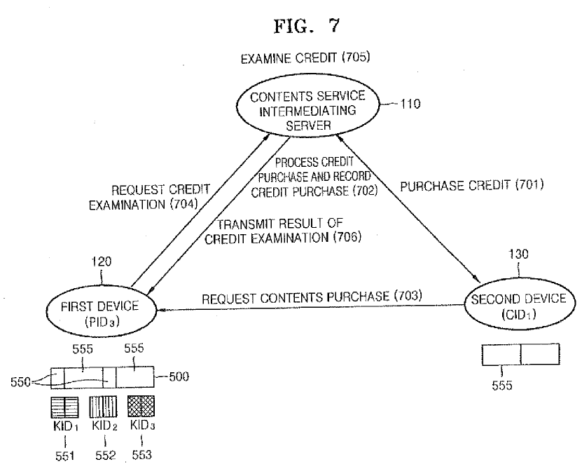

FIG. 7 is a dataflow diagram illustrating a method of examining credit, according to an exemplary embodiment of the present invention. Referring to FIG. 7, the contents purchasing unit 131 of the second device 130 purchases contents via the contents service intermediating server 110. That is, the contents purchasing unit 131 of the second device 130 purchases credit indicating a privilege granted to a customer for acquiring contents (Operation 701). The credit can be purchased with cash or by using a credit card or electronic money used to make an online purchase. However, the present inventive concept is not limited thereto and any methods of providing a right to use the contents on line or off line can be used to purchase the credit. The credit management unit of the contents service intermediating server 110 processes a customer's credit purchase by making a charge for the contents as provided and records credit information including customer's identification information CID₁ in the storage unit 114 (Operation 702).

The contents purchasing unit 131 of the second device 130 transmits a contents purchase request to the first device 120 (Operation 703). The trading unit 122 of the first device 120 requests the contents service intermediating server 110 to examine whether a customer has a right to purchase the contents by transmitting the requesting customer's identification information CID₁ to the contents service intermediating server 110 (Operation 704). The credit management unit 113 of the contents service intermediating server 110 examines the customer's credit based on credit records 117 stored in the storage unit 114 (Operation 705) and transmits credit examination result information, if the customer has the right to purchase the contents, to the first device 120 (Operation 706).

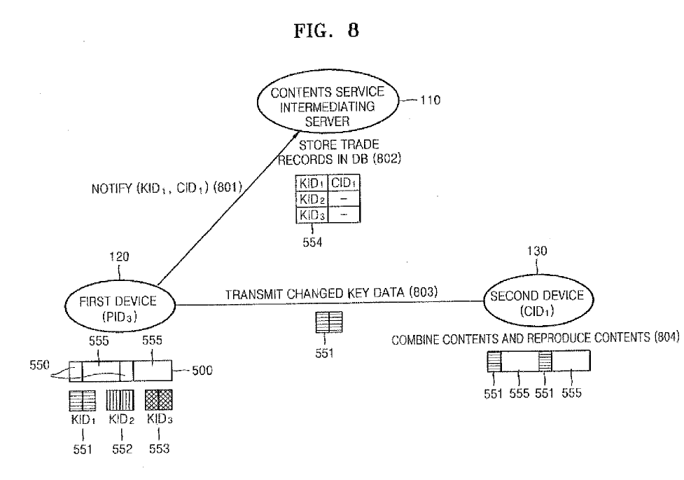

FIG. 8 is a dataflow diagram illustrating a method of reproducing contents, according to an exemplary embodiment of the present invention. Referring to FIG. 8, if the credit examination result is positive, the trading unit 122 of the first device 120 notifies the contents service intermediating server 110 that the customer has purchased one of the changed key data 551, 552, and 553 of the contents (Operation 801). The trade management unit 112 of the contents service intermediating server 110 stores the trade records 116 indicating that a customer corresponding to CID₁ has purchased contents corresponding to KID₁ in the DB 554 (Operation 802). The trading unit 122 transmits the changed key data 551 that has been purchased by the customer to the second device 130 (Operation 803). The trading unit 122 of the first device 120 can store sale records in the storage unit 123 for future reference. If the trading unit 122 receives the credit examination result informing that the customer has no credit, the trading unit 122 rejects the customer's purchase request. The reproducing unit 132 of the second device 130 combines the changed key data 551 and the non-key portion 555 of the contents and reproduces the combination (Operation 804). If the second device 130 stores the changed key data 551 in the storage unit 130, the reproducing unit 132 can use the contents without receiving the changed key data 551 from a contents provider. The reproducing unit 132 can duplicate a contents file including the changed key data 551, 552, and 553 and reproduce the contents.

The first device 120 provides the second device 130 with a different piece of the changed key data whenever the contents are traded. Therefore, customers who have purchased the same contents can acquire different contents files. In other words, each customer acquires a slightly different contents file because of different fingerprints or watermarks which are added to the changed key data 555 by the contents service intermediating server 110. However, such a difference cannot be identified when the contents file is reproduced. As such, it is possible to achieve a one-to-one relationship between a customer and contents purchased by the customer and track how a purchased contents file was distributed.

FIG. 9 is a dataflow diagram illustrating a method of protecting contents from unauthorized duplication, according to an exemplary embodiment of the present invention. In the present exemplary embodiment, a third device 140 resells a contents file including changed key data which has been purchased by a customer.

Referring to FIG. 9, the third device 140 has a duplicate of the contents (Operation 901), extracts key data 551 from the duplication and transmits the extracted key data 551 to the contents service intermediating server 110 in order to make a request for publishing the contents (Operation 902). The contents service intermediating server 110 examines the received key data 551 to determine whether the received key data 551 is changed (Operation 903), and if it is determined that the received key data 551 has been changed, i.e., if the contents file that the third device 140 is to resell is the duplication of the contents, notifies the third device 140 that it is not allowed to publish the contents (Operation 904). In Operation 903, the contents service intermediating server 110 extracts the previously inserted key value KID₁ from the received key data 551. The contents service intermediating server 110 can confirm from the DB 554 that a customer corresponding to CID₁ has purchased contents corresponding to KID₁, and register the customer CID₁ in a blacklist.

A method according to the present inventive concept as described above can be embodied as computer readable code on a computer readable recording medium.

According to the present invention as described above, open digital rights management (DRM) can make it possible to provide a contents service that is not subject to specific DRM. An application program interface (API) necessary for publishing, browsing, and reproducing contents is open, which makes it possible to easily realize software and a system used for trading contents at a reasonable cost. Therefore, a user can be provided with a cost-effective and good quality service via the competition of many service providers. Contents acquired by an authorized customer can be duplicated in different media and reproduced. A contents provider and a user can trade contents in person. A contents service intermediating server according to an exemplary embodiment of the present invention can easily form an open market where individuals publish contents, browse media, and purchase contents. A portion of contents excluding key data is transmitted to a customer in advance and a small amount of changed key data is transmitted to the customer when the contents is purchased, so that the contents can be purchased and reproduced in real-time. Unauthorized duplication of contents can be easily tracked when the contents are distributed.

While this present inventive concept has been particularly shown and described with reference to exemplary embodiments thereof, it will be understood by those skilled in the art that various changes in form and detail may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of intermediating a contents service, the method comprising:
changing at least part of contents to produce a plurality of pieces of changed key data which are different from each other; and
managing trading of the contents between a first device and a second device using the produced plurality of pieces of changed key data.

2. The method of claim 1, wherein the producing of the plurality of pieces of changed key data comprises:
receiving key data comprising the at least part of the contents that is necessary for reproducing the contents from the first device;
inserting different fingerprints into the received key data to produce the plurality of pieces of changed key data; and
transmitting the plurality of pieces of changed key data to the first device.

3. The method of claim 2, further comprising:
determining whether the received key data has been changed; and
if the received key data is determined to have been changed, notifying the first device that the contents are not allowed to be published.

4. The method of claim 3, further comprising:
extracting the fingerprints inserted into the key data that is determined to have been changed; and
determining which customer has purchased the key data that is determined to have been changed based on trade records corresponding to the extracted fingerprints.

5. The method of claim 1, wherein the managing of the trading of contents comprises:
receiving notification of contents purchase, including information on a customer who purchased the contents and information on one of the plurality of pieces of changed key data, from the first device; and
storing trade records associating the contents with the customer who purchased the contents.

6. The method of claim 1, further comprising:
managing credit indicating a privilege granted to a customer for acquiring the contents.

7. The method of claim 6, wherein the managing of the credit comprises:
receiving a request for examining the credit, the request including identification information on the customer from the first device;
examining the credit based on credit information of the customer; and
transmitting a result of the credit examination to the first device.

8. The method of claim 6, wherein the managing of the credit further comprises:
receiving a request for purchasing credit from the second device; and
recording credit information of a customer in response to the request.

9. A method of providing a contents service, the method comprising:
receiving a plurality of pieces of changed key data which are different from each other and are produced by changing at least part of contents; and
trading the contents using the received plurality of pieces of changed key data.

10. The method of claim 9, wherein the receiving of the plurality of pieces of changed key data comprises:
transmitting key data comprising the at least part of the contents that is necessary for reproducing the contents to a contents service intermediating server; and
receiving the plurality of pieces of changed key data which are different from each other from the contents service intermediating server.

11. The method of claim 9, wherein the plurality of pieces of changed key data are produced by inserting different fingerprints into the key data comprising the at least part of the contents.

12. The method of claim 9, wherein the trading of the contents comprises:
if a request for purchasing the contents is received from a second device, transmitting one of the plurality of pieces of changed key data to the second device.

13. The method of claim 12, wherein the trading of the contents further comprises: transmitting notification of contents purchase, including information on a customer who purchased the contents and information on the transmitted one piece of changed key data to the contents service intermediating server.

14. The method of claim 9, wherein the trading of the contents further comprises:
if a request for purchasing the contents is received from the second device, requesting the contents service intermediating server to examine credit in order to determine whether a customer who wishes to purchase the contents has a privilege for acquiring the contents; and
if it is determined by the contents service intermediating server that the customer has the privilege for acquiring the contents, transmitting one of the plurality of pieces of changed key data to the second device.

15. The method of claim 14, wherein the trading of the contents further comprises: transmitting notification of contents purchase, including information on a customer who purchased the contents and information on the transmitted one piece of changed key data to the contents service intermediating server.

16. A method of using a contents service, the method comprising:
transmitting a request for purchasing contents to a first device;
receiving changed key data, which is produced by changing key data including at least part of the contents, from the first device; and
combining the received changed key data and parts of the contents other than the key data.

17. The method of claim 16, further comprising:
transmitting a request for downloading the contents to the first device; and
receiving the parts of the contents from the first device.

18. The method of claim 16, further comprising:
purchasing credit indicating a privilege granted to a customer for acquiring the contents from a contents service intermediating server.

19. An apparatus for intermediating a contents service, the apparatus comprising:
a contents publishing unit which changes at least part of contents, produces a plurality of pieces of changed key data which are different from each other, and stores information on the plurality of pieces of changed key data in a storage unit; and
a trade managing unit which manages trading of the contents between a first device and a second device using the stored information on the plurality of pieces of changed key data.

20. The apparatus of claim 19, wherein the contents publishing unit receives key data containing the at least part of the contents that is necessary for reproducing the contents from the first device, inserts different fingerprints into the received key data to produce the plurality of pieces of changed key data, and transmits the plurality of pieces of changed key data to the first device.

21. The apparatus of claim 20, wherein the contents publishing unit determines whether the received key data has been changed, and if the received key data is determined to have been changed, notifies the first device that the contents are not allowed to be published.

22. The apparatus of claim 21, wherein the contents publishing unit extracts the fingerprints inserted into the key data that is determined to have been changed, and determines which customer has purchased the key data that is determined to have been changed based on trade records corresponding to the extracted keys.

23. The apparatus of claim 19, wherein, if the trade managing unit receives notification of contents purchase, including information on a customer who purchased the contents and information on one of the plurality of pieces of changed key data, from the first device, the trade managing unit stores the trade records associating the contents with the customer in the storage unit.

24. The apparatus of claim 19, further comprising: a credit managing unit which manages credit indicating a privilege granted to a customer for acquiring the contents.

25. The apparatus of claim 24, wherein, if the credit managing unit receives a request for examining the credit including identification information on the customer from the first device, the credit managing unit examines the credit based on credit information of the customer, and transmits a result of the credit examination to the first device.

26. The apparatus of claim 24, wherein, if the credit managing unit receives a request for purchasing credit from the second device, the credit managing unit records credit information of a customer in response to the request in the storage unit.

27. An apparatus for providing a contents service, the apparatus comprising:
a contents publishing unit which receives a plurality of pieces of changed key data which are different from each other and are produced by changing at least part of contents in a storage unit; and
a trading unit which trades the contents with a second device using the stored plurality of pieces of changed key data.

28. The apparatus of claim 27, wherein the contents publishing unit transmits key data containing the at least part of the contents that is necessary for reproducing the contents to a contents service intermediating server, and receives the plurality of pieces of changed key data which are different from each other from the contents service intermediating server.

29. The apparatus of claim 27, wherein the plurality of pieces of changed key data are produced by inserting different fingerprints into the key data comprising the at least part of the contents.

30. The apparatus of claim 27, wherein, if the contents trading unit receives a request for purchasing the contents from a second device, the contents trading unit transmits one of the plurality of pieces of changed key data to the second device, and transmits notification of contents purchase, including information on a customer who purchased the contents and information on the transmitted one piece of changed key data, to the contents service intermediating server.

31. The apparatus of claim 27, wherein, if the contents trading unit receives a request for purchasing the contents from the second device, the contents trading unit requests the contents service intermediating server to examine credit in order to determine whether a customer who wishes to purchase the contents has a privilege for acquiring the contents, and if it is determined that the customer has the privilege for acquiring the contents by the contents service intermediating server, transmits one of the plurality of pieces of changed key data to the second device, and transmits contents purchase information, including information on a customer who purchased the contents and information on the transmitted one piece of changed key data, to the contents service intermediating server.

32. An apparatus for using a contents service, the apparatus comprising:
a contents purchasing unit which transmits a request for purchasing contents to a first device, and receives changed key data from the first device which is produced by changing key data including at least part of the contents; and
a contents reproducing unit which combines the received changed key data and parts of the contents other than the key data in order to reproduce the contents.

33. The apparatus of claim 32, wherein the contents purchasing unit transmits a request for downloading the contents to the first device, and receives the parts of the contents from the first device.

34. The apparatus of claim 32, wherein the contents purchasing unit purchases credit from a contents service intermediating server, the credit indicating a privilege granted to a customer for acquiring the contents.

35. A contents service system including a contents service intermediating server, and first and second devices for trading contents,
wherein the contents service intermediating server changes key data of the contents to produce a plurality of pieces of changed key data which are different from each other,
the first device, if the first device receives a request for purchasing the contents from the second device, transmits one of the plurality of pieces of changed key data to the second device, and
the second device combines the transmitted a piece of changed key data and parts of the contents other than the key data in order to reproduce the contents.

36. The contents service system of claim 35, wherein the key data of the contents comprises at least part of the contents that is necessary for reproducing the contents.

37. The contents service system of claim 35, wherein the contents service intermediating server, before producing a plurality of pieces of changed key data which are different from each other, determines whether the key data has been changed, and if the received key data is determined to have been changed, notifies the first device that the contents are not allowed to be published.

38. The contents service system of claim 37, wherein the contents service intermediating server extracts fingerprints inserted into the key data that is determined to have been changed, and determines which customer has purchased the key data that is determined to have been changed based on trade records corresponding to the extracted keys.

39. The contents service system of claim 35, wherein the contents service intermediating server manages trade records of customers regarding the contents and, if the contents service intermediating server receives contents purchase information, including information on the customer who purchased the contents and information on one of the plurality of pieces of changed key data, from the first device, the contents service intermediating server stores the trade records associating the contents with the customer in a storage unit.

40. The contents service system of claim 35, wherein the contents service intermediating server manages customers credit indicating a privilege granted to a customer for acquiring the contents and, if the contents service intermediating server receives a request for examining the credit including identification information on the customer from the first device, the contents service intermediating server examines the credit based on credit information of the customer and transmits a result of the credit examination to the first device,
the first device, if it is determined that the customer has the privilege for acquiring the contents by the contents service intermediating server, transmits one of the plurality of pieces of changed key data to the second device, and transmits information on the customer who purchased the contents and information on the transmitted one piece of changed key data to the contents service intermediating server.

41. The contents service system of claim 35, wherein the contents service intermediating server manages customers credit indicating the privilege granted to a customer for acquiring the contents and, if the contents service intermediating server receives a request for purchasing credit from the second device, the contents service intermediating server records credit information of the customer in response to the request in the storage unit.

42. The contents service system of claim 35, wherein the first device extracts the key data comprising the at least part of the contents that is necessary for reproducing the contents and transmits the extracted key data to the contents service intermediating server.

43. The contents service system of claim 35, wherein the contents service intermediating server inserts different fingerprints into the key data comprising the at least part of the contents to produce the plurality of pieces of changed key data.

44. The contents service system of claim 35, wherein the second device transmits a request for downloading the contents to the first device, and receives the parts of the contents other than the key data from the first device.

45. The contents service system of claim 35, wherein the contents service intermediating server manages the customers credit indicating the privilege granted to a customer for acquiring the contents,
the second device purchases the customers credit indicating the privilege granted to a customer for acquiring the contents from the contents service intermediating server.

46. A computer readable recording medium storing a program for executing a method of intermediating a contents service according to claim 1.

47. A computer readable recording medium storing a program for executing a method of providing a contents service according to claim 9.

48. A computer readable recording medium storing a program for executing a method of using a contents service according to claim 16.
